(19) United States
(12) Patent Application Publication
(10) Pub. No.: US 2012/0005102 A1
(43) Pub. Date: Jan. 5, 2012

(54) Method and System for Anonymous Communication Between A Consumer and Provider

(76) Inventors: Robert Thomas McClung, Millbrae, CA (US); Erik Alan Landerholm, Foster City, CA (US); Michael Lawrence Young, San Francisco, CA (US)

(21) Appl. No.: 12/830,141

(22) Filed: Jul. 2, 2010

(51) Int. Cl. G06Q 30/00; G06Q 20/00

(52) U.S. Cl. 705/80; 705/26.42

(57) ABSTRACT

A method and system for anonymous communication between a consumer and a provider are disclosed. According to one embodiment, a computer-implemented method comprises receiving a first input from a consumer, the first input including an indication of intent to purchase a desired product. A plurality of providers is queried based on the first input to locate a matching provider, and the matching provider is notified about the consumer through a notification lead without revealing an identity of the consumer. Anonymous communications are provided regarding a purchase of the desired product between the consumer and the matching provider, wherein the anonymous communications include a price negotiation.

### FIELD

The field of the invention relates generally to computer systems. In particular, the present invention is directed to a method and system for anonymous communication between a consumer and a provider.

### BACKGROUND

Vehicle buying historically took place on a dealer's lot or through classified listings. In recent years, buyers have been able to peruse a dealer's posted inventory on their website. Although the posting of inventory is convenient, posted inventory is rarely reliable or up to date. Vehicle buying involves a posted sticker price by a dealership, however negotiation can get the price lowered for a savvy buyer. No two buyers will pay the same amount for the same vehicle.

Vehicle buying can involve harassment of a buyer by a dealer. A buyer inquiring about a vehicle price on-line is required to enter her name, email address, and phone number just to get a price quote. Price quote requests are intercepted and purchased by lead aggregators, and then delivered to dealers. Examples of lead aggregators include Dealix, Autobytel, DTX, and AutoUSA. Dealers can then send unlimited emails to the buyer and call the buyer frequently.

Direct negotiation with a dealer is difficult even for the most savvy buyer, and dealers typically can go lower in price. Buyers are left in the situation of not knowing whether they have received a good or bad deal.

### SUMMARY

A method and system for anonymous communication between a consumer and a provider are disclosed. According to one embodiment, a computer-implemented method comprises receiving a first input from a consumer, the first input including an indication of intent to purchase a desired product. A plurality of providers is queried based on the first input to locate a matching provider, and the matching provider is notified about the consumer through a notification lead without revealing an identity of the consumer. Anonymous communications are provided regarding a purchase of the desired product between the consumer and the matching provider, wherein the anonymous communications include a price negotiation.

The above and other preferred features, including various novel details of implementation and combination of elements, will now be more particularly described with reference to the accompanying drawings and pointed out in the claims. It will be understood that the particular methods and implementations described herein are shown by way of illustration only and not as limitations. As will be understood by those skilled in the art, the principles and features described herein may be employed in various and numerous embodiments without departing from the scope of the invention.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

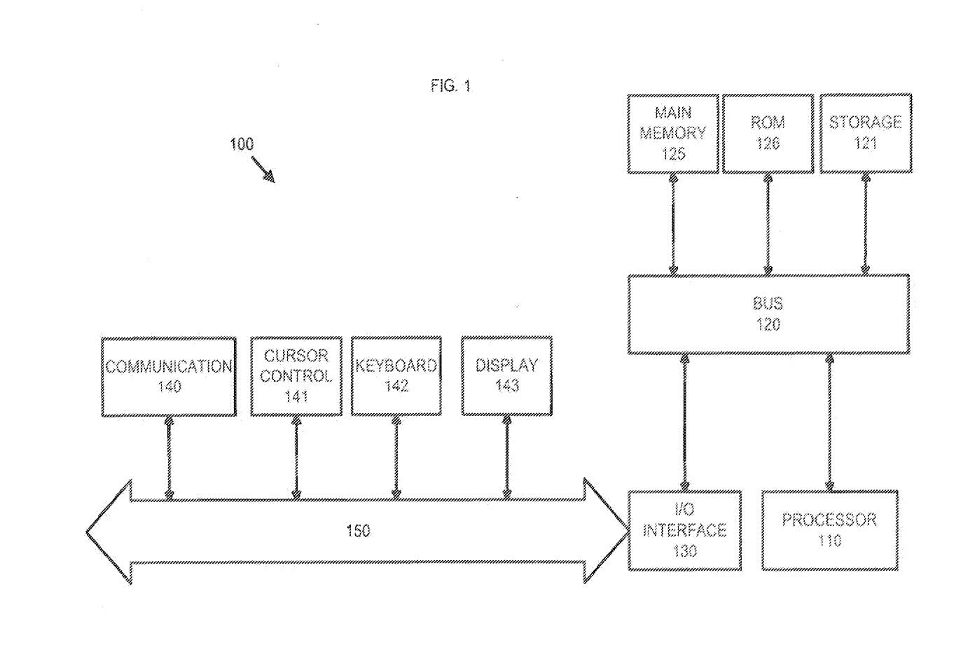

FIG. 1 illustrates an exemplary computer architecture for use with the present system, according to one embodiment.

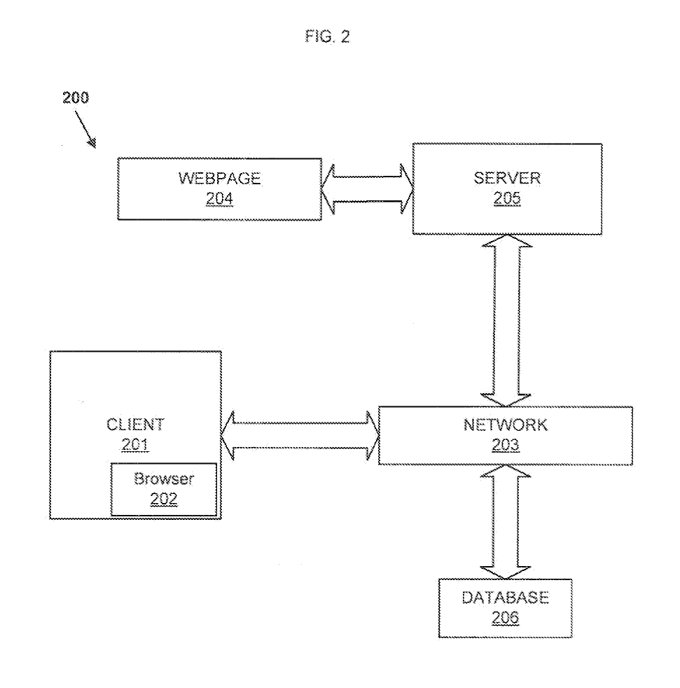

FIG. 2 illustrates an exemplary system architecture for use with the present system, according to one embodiment.

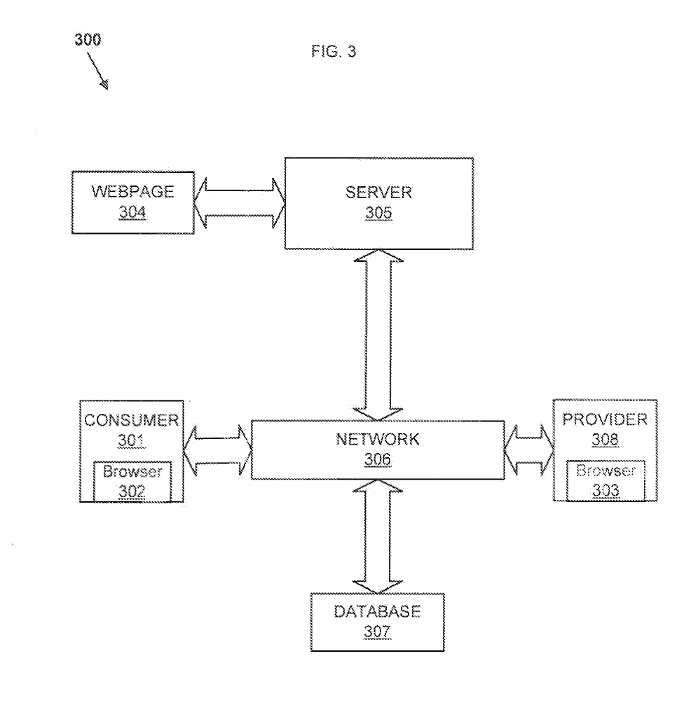

FIG. 3 illustrates an exemplary system architecture including a consumer and a provider for use with the present system, according to one embodiment.

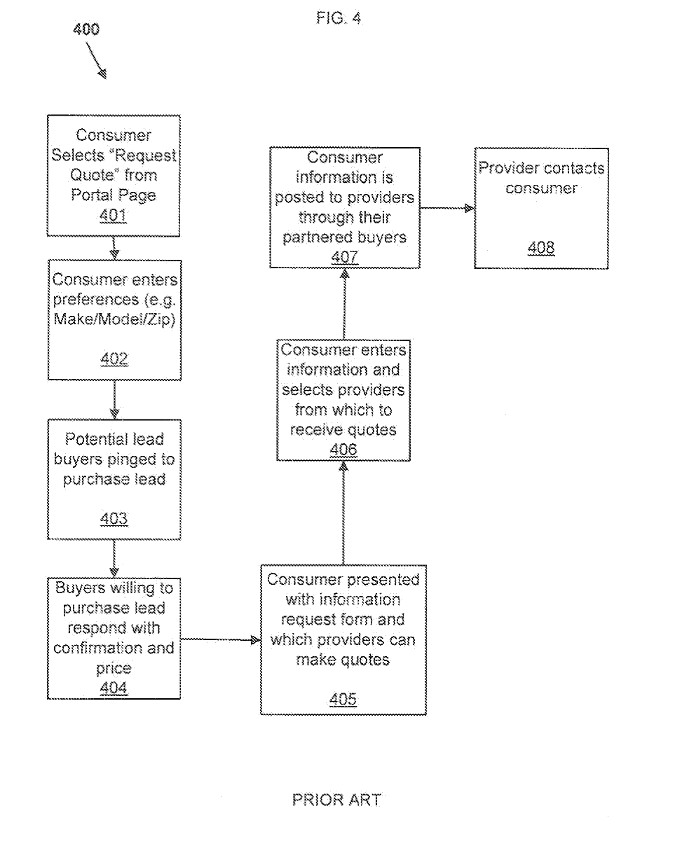

FIG. 4 illustrates an exemplary prior art consumer interaction process.

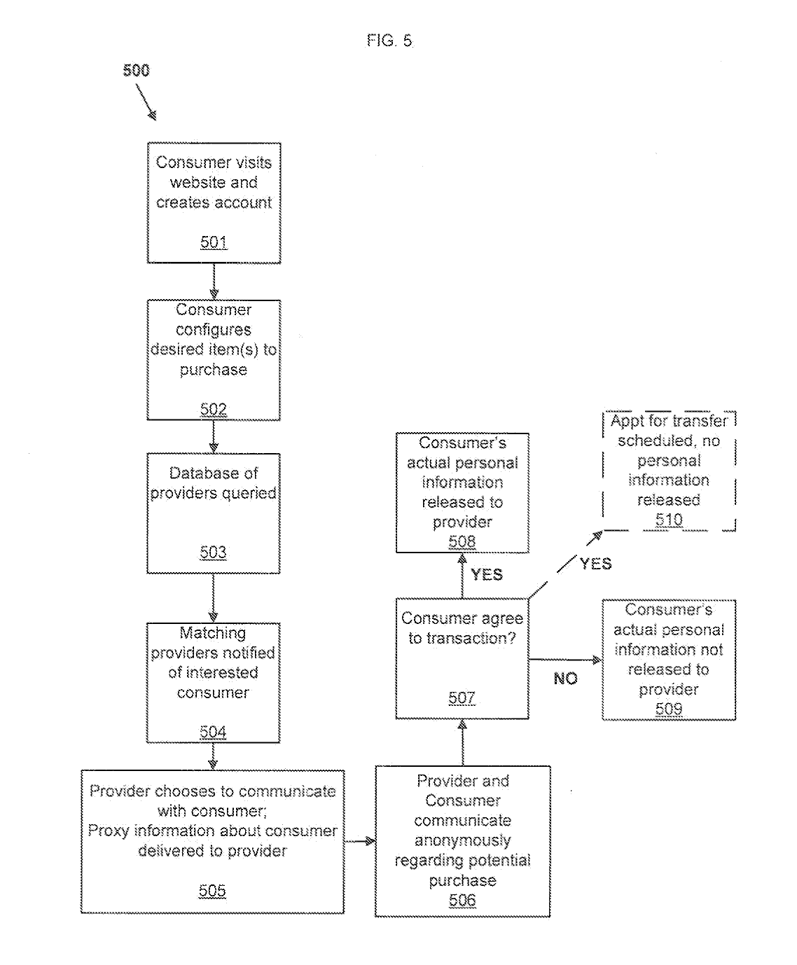

FIG. 5 illustrates an exemplary consumer interaction process for use with the present system, according to one embodiment.

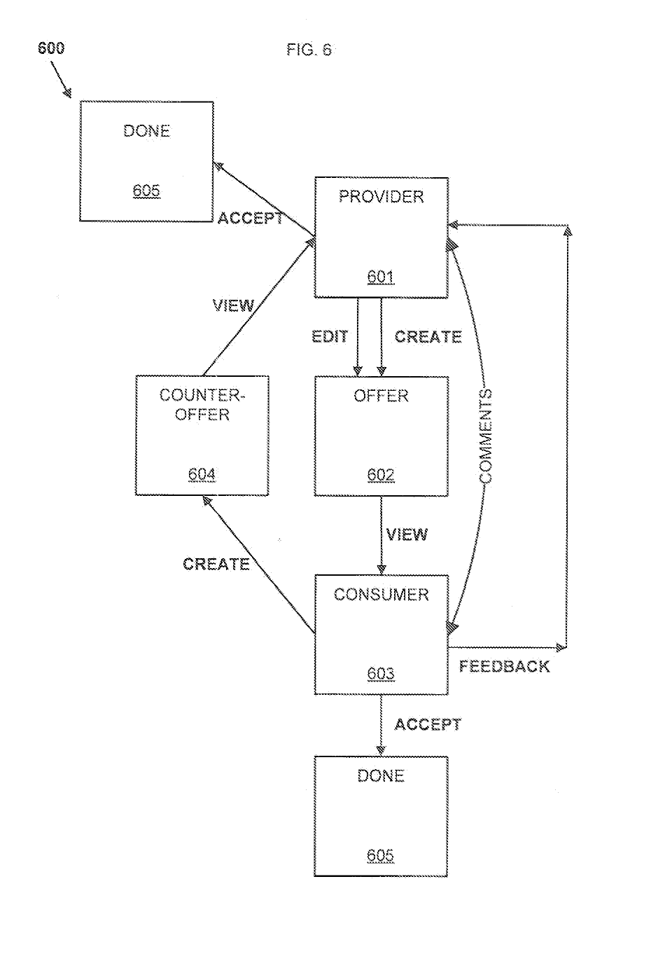

FIG. 6 illustrates exemplary anonymous communication between a consumer and a provider for use with the present system, according to one embodiment.

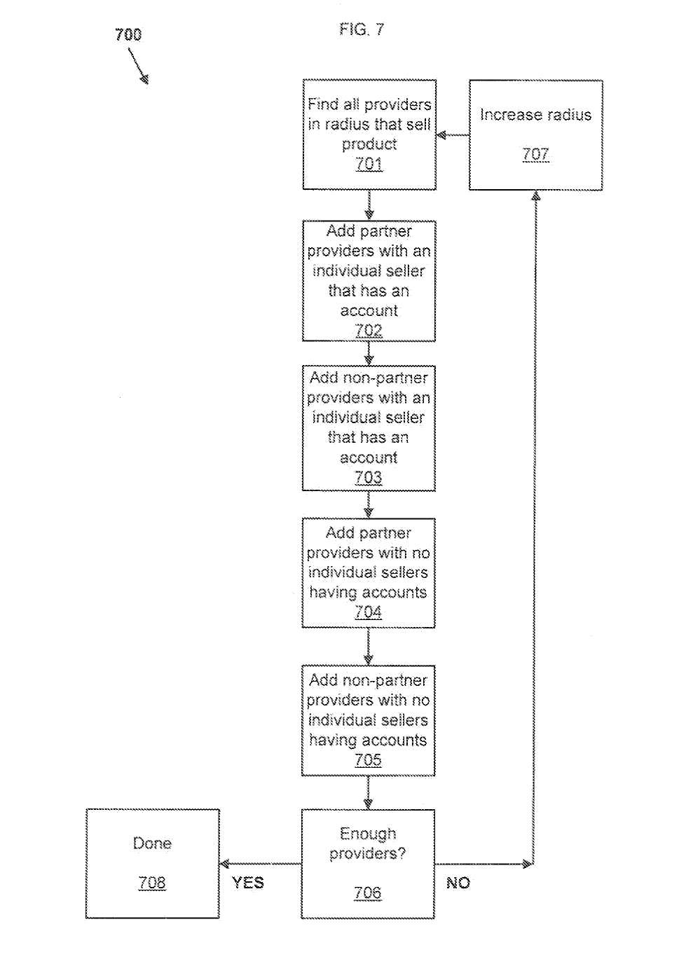

FIG. 7 illustrates an exemplary querying process for use with the present system, according to one embodiment.

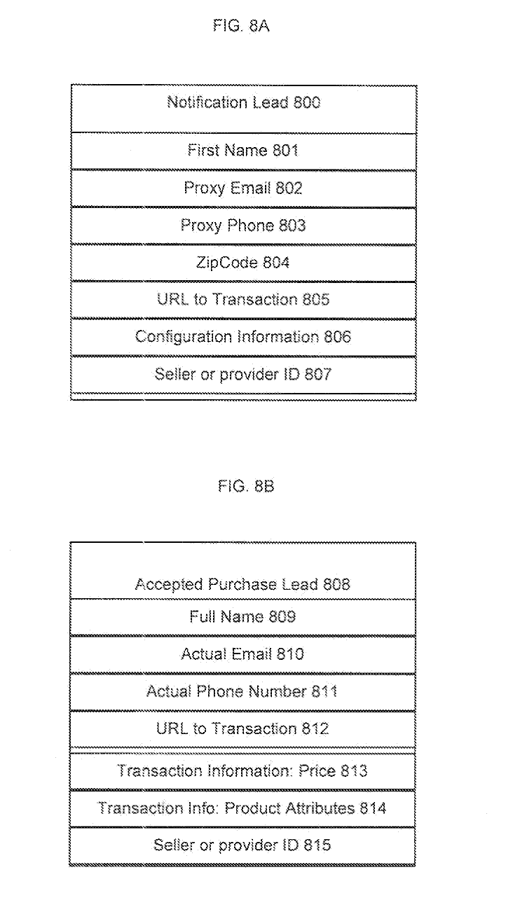

FIG. 8A illustrates an exemplary notification lead for use with the present system, according to one embodiment.

FIG. 8B illustrates an exemplary accepted purchase lead for use with the present system, according to one embodiment.

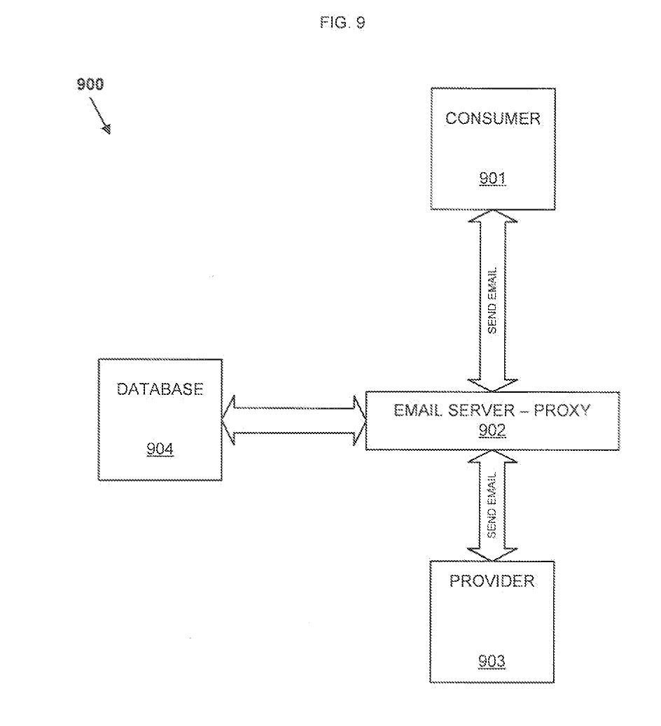

FIG. 9 illustrates exemplary proxy email communication between a consumer and a provider for use with the present system, according to one embodiment.

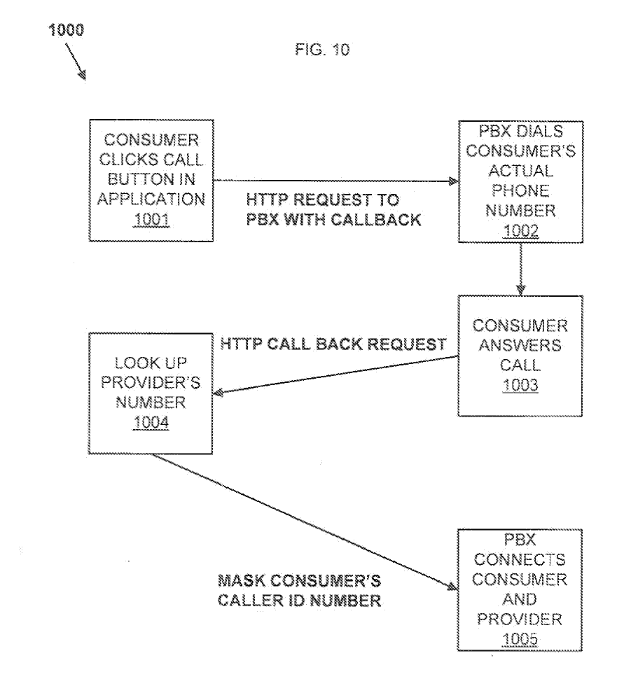

FIG. 10 illustrates exemplary proxy telephone communication between a consumer and a provider for use with the present system, according to one embodiment.

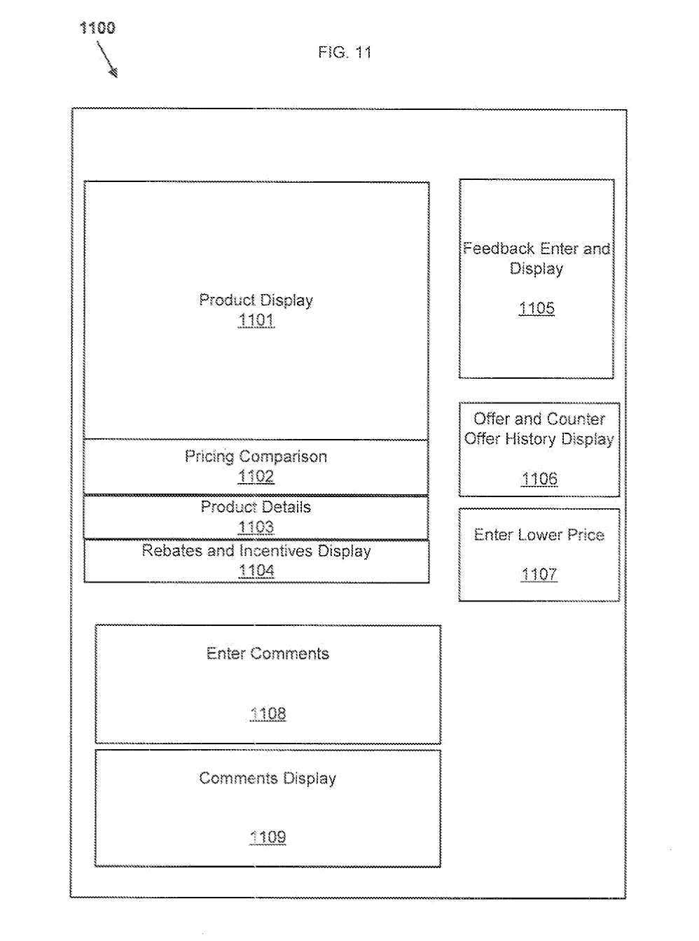

FIG. 11 illustrates an exemplary user interface including an offer for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A method and system for anonymous communication between a consumer and a provider are disclosed. According to one embodiment, a computer-implemented method comprises receiving a first input from a consumer, the first input including an indication of intent to purchase a desired product. A plurality of providers is queried based on the first input to locate a matching provider, and the matching provider is notified about the consumer through a notification lead without revealing an identity of the consumer. Anonymous communications are provided regarding a purchase of the desired product between the consumer and the matching provider, wherein the anonymous communications include a price negotiation.

According to one embodiment, a provider in the present system is a vehicle dealer. In other embodiments, the provider is any seller of a product desired by a consumer. A consumer, according to one embodiment of the present system, is a user interested in purchasing a vehicle. In other embodiments, the consumer is a user interested in purchasing a product. A lead buyer, according to one embodiment of the present system, is a lead purchaser. Lead purchasers can be lead aggregators or providers. Providers can purchase leads from lead aggregators, wholesale lead buyers, and OEM lead buyers.

According to one embodiment, the present system enables communication with providers on behalf of a consumer and solicits offers from the providers. Providers present offers to the consumers based on immediate inventory by communicating through a website provided by the present system.

According to one embodiment, the present system receives input from a consumer in the form of a desired product. An example product is a vehicle, and the input associated with the vehicle includes make, model, and year. Other preferences that a consumer can indicate include but are not limited to color, options, and location. A consumer can indicate a desired color, or indicate that a particular color is not acceptable. A consumer can also indicate no preferences.

According to one embodiment, the present system displays offers to consumers in a single interface. A consumer can compare all offers in the interface. Offers are compared using displayed independent third-party data from trusted sites like Kelly Blue Book, Edmunds, and TrueCar.

According to one embodiment, the present system enables a transaction between a provider and a consumer through online negotiating so that the vehicle (or transacted product) can be transferred in person without any additional negotiating.

According to one embodiment, the present system keeps consumers anonymous from providers until a consumer elects to provide personal information to the provider by agreeing to a transaction.

According to one embodiment, consumers utilizing the present system have the option of being removed from negotiating vehicle or product price. The present system conducts negotiations on behalf of the consumer to get the best price and reduce hassle incurred by the consumer.

According to one embodiment, consumers can provide feedback and rate providers. Ratings impact repeat business for a provider through the present system.

Messages exchanged with providers, according to one embodiment of the present system, are in ADF format. ADF format is Auto-Lead Data Format (ADF) and is an XML-based standard used in the automotive industry for formatting data involved with automotive sale.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as: but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 125 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 illustrates an exemplary system architecture for use with the present system, according to one embodiment. An exemplary system architecture 200 includes a client 201 having a browser 202 in communication with a network 203. A database 206 and a server 205 are also in communication with the network 203. The server 205 hosts a webpage 204 accessible to the client 201 browser 202 via the network 203. A consumer using the client 201 views the webpage 204 hosted by the server 205 via the browser 202. The client 201, database 206 and server 205 have architectures similar to that described in FIG. 1, according to one embodiment.

FIG. 3 illustrates an exemplary system architecture including a consumer and a provider for use with the present system, according to one embodiment. An exemplary system architecture 300 includes a consumer 301 having a browser 302 in communication with a network 306. A provider 308 having a browser 303 is in communication with the network 306. A database 307 and a server 305 are also in communication with the network 306. The server 305 hosts a webpage 304 accessible to the browsers 302, 303 via the network 306. The consumer 301 and provider 308 communicate via the network, an example of such communication is explained below in FIG. 5. The consumer system 301, provider system 308, database 307, and server 305 have architectures similar to that described in FIG. 1, according to one embodiment.

FIG. 4 illustrates an exemplary prior art consumer interaction process. A prior art consumer interaction process 400 begins with a consumer interested in purchasing a vehicle selecting to request a price quote for vehicles from a portal page 401. The consumer then enters preferences on a subsequent page 402. The preferences typically include a vehicle make, model, and a zip code where the consumer is interested in picking up the vehicle. Potential lead buyers are queried 403, offering them the opportunity to purchase the lead that is about to be generated. Those lead buyers willing to purchase the lead respond with a confirmation that they are indeed willing to purchase the lead and what price they will pay for it 404. The consumer is then presented with an information request form and a list of providers who would be willing to present offers 405. The consumer enters personal and contact information and selects which providers he or she is interested in receiving quotes from 406. The personal and contact information include but are not limited to a first and last name, email address, physical address, and phone number. The consumer information is posted to the providers through their partnered buyers (who purchased the lead) 407, and the provider is free to contact the consumer directly 408.

FIG. 5 illustrates an exemplary consumer interaction process for use with the present system, according to one embodiment. A consumer and provider interact using an exemplary architecture as described in FIG. 3. An exemplary consumer interaction process 500 begins when a consumer visits a site and creates an account 501. A consumer may directly visit the site or be redirected from another site or widget to the site. Creating an account 501 involves receiving input from the consumer. The received input includes but is not limited to a first and last name, zip code, email address, and a password. The consumer configures one or more desired items to purchase 502. The configured desired items to purchase are stored in a database and are associated with a user ID of the consumer (the user ID having been generated upon creating an account).

In other embodiment, the consumer selects an item that is already configured from a list of inventory posted by a provider rather than configuring an item.

In other embodiments, a consumer does not need to create an account. Instead a unique identifier is created and associated with a potential purchase (configured by the consumer), and both the consumer and a dealer have access to the identifier and use it to communicate regarding the potential purchase.

A database of providers is queried for providers who have the ability to provide the item that consumer wants to purchase 503. According to one embodiment, additional providers are queried for potential inclusion in the opportunity to try to sell the item to the consumer in this anonymous format. According to one embodiment, the query is transmitted in ADF format.

The matching providers are notified of an interested consumer 504. Provider notification can be through email, text, Twitter post, a Facebook message, a notice to their account dashboard, ADF, other lead delivery format, or a phone call, according to one embodiment. The notification prompts the provider to log into their account with the present system, and if they do not have an account they are prompted to register first.

A provider, or multiple providers, chooses to communicate with the consumer 505. Communication is initiated through a URL embedded in the received notification. The providers can only see proxy information, including the consumer's first name, last initial, the configured desired item, preferences, and a distance from the provider where the consumer resides, according to one embodiment.

The consumer and providers communicate anonymously regarding a potential purchase 506. Communication between the consumer and the providers are through their respective accounts with the website, with notification of a new message being received by the respective party from a server (as detailed in FIG. 3) through text or email, according to one embodiment. In other embodiments, communication between the consumer and the provider is anonymous through proxy email and proxy phone numbers as described in FIGS. 9 and 10. Communications, according to one embodiment, include comments, offers, counter offers, and requests for phone calls.

The consumer can then agree to a transaction 507 and the consumer's actual personal information is released to the provider 508. If the consumer does not agree to the transaction then the consumer's actual personal information is not released to the provider 509.

According to another embodiment, the consumer's actual personal information is not released to the dealer upon agreement transaction. Instead, an appointment for transfer of the purchased item is agreed upon by the consumer and the provider 510. Upon accepting or agreeing to the transaction, a certificate is delivered to the consumer. The certificate presents information regarding the agreed upon transaction, including but not limited to negotiated price and a transaction ID. The provider receives the transaction ID so that both the provider and consumer have the transaction ID to complete the transaction. The consumer can present the certificate to the provider to finalize the transaction. The certificate can be printed and physically transferred to the provider by the consumer, or the certificate can be electronic.

According to one embodiment, communications between a consumer and provider are limited to a time window. An offer made by a provider to a consumer expires according to a time window defined by the provider. A communication session relating to a particular transaction expires according to a time window defined by the consumer or a system administrator.

FIG. 6 illustrates exemplary an anonymous communications process between a consumer and a provider for use with the present system, according to one embodiment. An exemplary anonymous communication process 600 between a consumer 603 and a provider 601 includes an offer 602 that can be created and edited by the provider 601. The consumer 603 can view the offer 602 and accept it to move to a done state 605 to end the transaction. The consumer 603 can create a counter-offer 604 that the provider 601 can accept to move to the done state 605 and end the transaction. The provider 601 and consumer 603 can exchange comments, and the consumer 603 can provide feedback to and about the provider 601.

FIG. 7 illustrates an exemplary querying process for use with the present system, according to one embodiment. Providers and their associated information are stored in a database that is queried. An exemplary system architecture including a database storing providing information is detailed in FIG. 3. The information associated with each provider includes yet is not limited to products the provider is able to sell, location, whether the provider is a partner provider, and whether the provider has a registered individual (the individual has an account with the website according to the present system). A partner provider is a provider that has a partnership account, where a partnership account includes an agreement to purchase anonymous leads.

An exemplary querying process 700 includes searching for all providers in a particular radius that sell the consumer's desired product 701. The radius is defined according to a distance from the consumer's zip code. The radius is defined by a preference indicated by the consumer, or a default radius is defined by a system administrator.

According to one embodiment, partner providers with an individual seller that has an account are added to a list of providers to present to the consumer 702. Non partner providers with an individual seller that has an account are then added to the list of providers 703. Partner providers with no individual sellers having accounts are then added to the list of providers 704, and finally non-partner providers with no individual sellers having accounts are added to the list of providers 705. If there are not enough providers in the list of providers 706 then the radius is increased 707 and the database queried again. If there are enough providers in the list 706, the query process is done 708.

It will be appreciated that adding providers to the list of providers to be presented to the consumer is based on partner and account priority in the present description, however any mode of prioritization based upon provider information is acceptable.

FIG. 8A illustrates an exemplary notification lead for use with the present system, according to one embodiment. A notification lead 800 includes a first name 801, a proxy email 802, a proxy phone number 803, a zip code 804, a URL to a purchase/transaction 805, configuration information 806, and a seller or provider ID 807. The seller or provider ID is for lead aggregator to know who to deliver the lead to. According to one embodiment, a notification lead is released to the provider in ADF format.

FIG. 8B illustrates an exemplary accepted purchase lead for use with the present system, according to one embodiment. An accepted purchase lead 808 is a result of the consumer and provider having agreed to a transaction and the consumer's information can be released to the provider. Agreement to a transaction includes the consumer agreeing to purchase an item from the provider at a particular price.

An accepted purchase lead 808 includes a full name 809, an actual email 810, an actual phone number 811, a URL to a purchase/transaction 812, transaction information including negotiated price 813, transaction information including product attributes 814, and a seller or provider ID 815.

According to one embodiment, the provider does not receive a notification of an accepted purchase. Instead, the provider sees the accepted purchase in her account dashboard.

According to one embodiment, actual consumer information is released by a server upon acceptance of a transaction through an email to the provider, an accepted purchase lead as described in FIG. 8A, an SMS, a phone call, or posted to the website for the provider to view upon logging into an account. An exemplary system architecture including a provider, consumer, and server is detailed in FIG. 3.

FIG. 9 illustrates exemplary proxy email communication between a consumer and a provider for use with the present system, according to one embodiment. Exemplary proxy email communication 900 includes a consumer 901 sending an email to a proxy email server 902. The proxy email server 902 includes actual provider email addresses. The proxy email server 902 queries a database 904 for the provider email address and sends the email sent by the consumer 901 to the provider 903. The consumer's 901 email address is changed to a proxy email address in the message received by the provider. The provider 903 can send an email to the consumer's proxy email address and the proxy email server 902 queries the database 904 for the consumer's actual email address for delivery in the same manner.

According to one embodiment, the proxy email server 902 and the database 904 are within the same system.

FIG. 10 illustrates an exemplary proxy telephone communications process between a consumer and a provider for use with the present system, according to one embodiment. An exemplary proxy telephone communications process 1000 begins with a consumer clicking on a call button in an application 1001. A request is transmitted to an HTTP enabled private branch exchange (PBX). A private branch exchange is a telephone exchange that serves a particular population, as opposed to a common carrier. The PBX dials the consumer's actual phone number 1002 and the consumer answers the call 1003. An http request is sent to a server that looks up the provider's phone number 1004. The consumer's phone number is masked on caller ID, and PBX connects the consumer and provider 1005.

FIG. 11 illustrates an exemplary user interface including an offer for use with the present system, according to one embodiment. An exemplary user interface 1100 includes a product display 1101. A product display 1101 can be an image of the product and a product name. A pricing comparison 1102 is displayed including, for example, MSRP, current price, savings. Product details 1103 are displayed, including options and specifications, and rebates and incentives included in the offer are displayed 1104. A section for entering comments 1108 is available along with a display of comments 1109 that have been previously entered. Feedback regarding the offer can be entered and the history of feedback is displayed 1105. The offer and counter offer history is displayed 1106, and a section for entering a lower price is displayed 1107.

It will be appreciated that, while the present system and method are described herein with relation to vehicle purchasing, the present system and method are applicable to any anonymous communication between a consumer and a provider.

A method and system for anonymous communication between a consumer and a provider have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

We claim:

1. A computer implemented method, comprising:
receiving a first input from a consumer, the first input including an indication of intent to purchase a desired product;
querying a plurality of providers based on the first input to locate a matching provider;
notifying the matching provider about the consumer through a notification lead without revealing an identity of the consumer; and
providing anonymous communications regarding a purchase of the desired product between the consumer and the matching provider, wherein the anonymous communications include a price negotiation.

2. The computer-implemented method of claim 1, wherein the consumer agrees to purchase the desired product at a negotiated price from the matching provider.

3. The computer-implemented method of claim 1, wherein anonymous communication terminates in response to an expired time limit for communication, wherein the time limit is set by one of the matching provider or the consumer.

4. The computer-implemented method of claim 2, wherein a certificate is delivered to the consumer to redeem for the desired product at the negotiated price.

5. The computer-implemented method of claim 2, wherein actual contact information associated with the consumer is delivered to the matching provider through an accepted purchase lead.

6. The computer-implemented method of claim 1, wherein the matching provider anonymously performs at least one of create an offer, edit an offer, send a comment to the consumer, view a counter offer, and accept a counter offer.

7. The computer-implemented method of claim 1, wherein the consumer anonymously performs at least one of view an offer, send a comment to the matching provider, deliver feedback to the matching provider, deliver feedback about the matching provider, create a counter offer, and accept an offer.

8. The computer-implemented method of claim 1, wherein querying the plurality of providers comprises calculating a radius based on the first input and selecting a provider based on the radius, the desired product, and a priority.

9. The computer-implemented method of claim 1, wherein the notification lead includes at least one of a first name, a proxy email address, a proxy phone number, a zip code, a transaction URL, configuration information, and a provider ID.

10. The computer-implemented method of claim 5, wherein the accepted purchase lead includes at least one of a full name, an actual email address, an actual phone number, a transaction URL, transaction information, and a provider ID.

11. The computer implemented method of claim 1, wherein the desired product is selected from an inventory list posted by a provider.

12. A system, comprising:
a client having a browser in communication with a network, wherein a database is in communication with the network; and
a server hosting a webpage in communication with a network, wherein the client accesses the webpage through the browser, wherein the server
receives a first input from a consumer, the first input including an indication of intent to purchase a desired product;
queries a plurality of providers based on the first input to locate a matching provider;
notifies the matching provider about the consumer through a notification lead without revealing an identity of the consumer;
provides anonymous communications regarding a purchase of the desired product between the consumer and the matching provider, wherein the anonymous communications include a price negotiation.

13. The system of claim 12, wherein the consumer agrees to purchase the desired product at a negotiated price from the matching provider.

14. The system of claim 12, wherein anonymous communication terminates in response to an expired time limit for communication, wherein the time limit is set by one of the matching provider or the consumer.

15. The system of claim 13, wherein a certificate is delivered to the consumer to redeem for the desired product at the negotiated price.

16. The system of claim 13, wherein actual contact information associated with the consumer is delivered to the matching provider through an accepted purchase lead.

17. The system of claim 12, wherein the matching provider anonymously performs at least one of create an offer, edit an offer, send a comment to the consumer, view a counter offer, and accept a counter offer.

18. The system of claim 12, wherein the consumer anonymously performs at least one of view an offer, send a comment to the matching provider, deliver feedback to the matching provider, deliver feedback about the matching provider, create a counter offer, and accept an offer.

19. The system of claim 12, wherein querying the plurality of providers comprises calculating a radius based on the first input and selecting a provider based on the radius, the desired product, and a priority.

20. The system of claim 12, wherein the notification lead includes at least one of a first name, a proxy email address, a proxy phone number, a zip code, a transaction URL, configuration information, and a provider ID.

21. The system of claim 16, wherein the accepted purchase lead includes at least one of a full name, an actual email address, an actual phone number, a transaction URL, transaction information, and a provider ID.

22. The system of claim 12, wherein the desired product is selected from an inventory list posted by a provider.
